(19) United States
(12) Patent Application Publication
(10) Pub. No.: US 2011/0041537 A1
(43) Pub. Date: Feb. 24, 2011

(54) Desiccant based absorption dehumidifier, desiccant regenerator and methods

(76) Inventor: John Yenkai Pun, Coos Bay, OR (US)

Correspondence Address: John Yenkai Pun, USPS, P.O. Box 1747, Coos Bay, OR, 97420, US

(21) Appl. No.: 12/583,497

(22) Filed: Aug. 20, 2009

(51) Int. Cl. B01D 53/28; F25D 23/00

(52) U.S. Cl. 62/271

(57) ABSTRACT

The present invention relates to an apparatus and methods employing halogen lithium chloride for dehumidification in air conditioning. More particularly, the present invention is comprised of a dehumidifier with concentrated aqueous halogen lithium chloride as desiccant and regenerator (or concentrator) of diluted desiccant for reuse. The dehumidification portion of the apparatus utilizes woven fiberglass cloth in a construction that presents a very large surface area with required characteristics to support efficient and rapid interaction between desiccant and air. The construction also allows air to move between a large number of parallel arranged corridors of woven fiberglass cloth wetted with desiccant for interaction. Evaporation of water from diluted desiccant is aided by use of vacuum to lower water evaporation temperature, and electronically controlled microwave is employed to heat only the solution for desiccant regeneration to save energy.

### BACKGROUND OF INVENTION

The present invention relates to an apparatus and methods of using lithium chloride as a desiccant and its regeneration in application of relative humidify control in air conditioning.

Dehumidification has long existed using refrigeration, with many shortcomings, to reduce air temperature below dew point and condense water molecules from air. Electrical usage is high using refrigeration that causes icing of evaporator, degrades performance, creates discomfort for occupants, and may require periodic heating for deicing to reach comfortable temperature. Only room size dehumidifiers are available for domestic use based on refrigeration system requiring air temperature fall below dewpoint.

Two categories of desiccant dehumidifiers are manufactured for large installations such as hospitals, shopping malls, and manufacturing facilities as described by prior arts U.S. Pat. Nos. 5,448,895; 5,564,281; 5,791,153; 5,826,641; 7,338,548; and 7,363,770 using large rotating wheel embedded with silica gel crystals. Moisture in air is physically trapped in very small crevices and channels of the silica gel crystals in an adsorption method at one part of wheel with moist air blowing through a pipe. Regeneration is conducted using hot dry air blowing through the wheel at 180° opposite the dehumidifying air pipe. This type of dehumidification takes a large space and is not efficient as well as being very expensive. A class of liquid desiccants, halogen, is much more effective in absorbing water moisture from air but is very corrosive to metals such as stainless steel. Stainless steel immersed in a halogen solution such as lithium chloride develops cracks within 18 hours. These desiccants are not popular with most manufacturers. Only one manufacturer of dehumidifier, AIG Research, uses lithium chloride. At first titanium plates are used with wick (material not specified by AIG) lying on top for the desiccant to interact with moist air blowing through. Hot dry air is then blown through the same assembly in desiccant regeneration. This arrangement obviously indicates that time must be shared alternately by dehumidification and regeneration. Very large size and high cost characterize this dehumidifier. Injection molded plastic is later used replacing titanium as supporting structure. However plastic does not provide a good wetting surface for the desiccant so wick (?) is still being used. Employing hot air to evaporate water content in the solution is also very energy intensive.

There are some prior arts that use very undesirable materials for wetting with desiccant. Cellulose sponge is used as a wetting base in U.S. Pat. No. 6,546,746 having small wetting area and large body that soaks up a large amount of desiccant before it produces excess fluid draining into reservoir for transport to be regenerated. U.S. Pat. No. 6,000,684 describes the use of paper as wetting wick. Unfortunately paper disintegrates after long exposure to aqueous solutions especially when air is circulating on the paper. There are prior arts not disclosing what is used as a wetting base such as in U.S. Pat. No. 6,189,869. A few prior arts U.S. Pat. Nos. 5,213,154; 6,138,470; 6,216,483 utilize high energy consuming boiler for evaporation of water content from dilute desiccant.

Dehumidification's importance has been slighted over the years in US by air conditioner manufacturers. Depending of the weather of a region, most areas in America are affected adversely by high humidity. In these areas, the higher the temperature the greater is the humidity. Over 30% to 60% energy can be devoted to the decrease of humidity to reach a comfortable level in traditional compressor, condenser, and evaporator type air conditioner claimed by large capacity wheel type or desiccant based dehumidifier manufacturers. Air conditioner manufacturers depend on removal of humidity in air by bringing a building's temperature below dew point. A separate dehumidifier that can save energy as well as provide comfort is simply not in their plans. It is interesting to note that only a room size refrigeration type is available for domestic use. We have forgotten that a few year back France lost over 12,000 people due to heat stroke in an unexpected heat wave. Heat stroke is caused by heat plus high humidity that prevent people from sweating cooling themselves. The world today still does not have a dehumidifier that is efficient, chemically inert, uses little energy, and low cost enough to be incorporated into an air conditioning unit in every house. This invention takes advantages of principles and proven facts in physics and chemistry that have been neglected in air conditioning engineering in design of a dehumidifier that can be easily manufactured with reasonable cost. The dehumidifier can be made with a narrow profile that fits in a wall made with 2 by 4 lumber. It can operate inline with a recently invented heat exchanger. This dehumidifier can be as stand alone unit for a room or be made much larger for commercial applications.

### SUMMARY

The present invention is an apparatus constructed with materials chemically inert to lithium chloride that forms desiccant wetting base. Moreover, the wetting base provides a very large surface area for coating of thin desiccant film to interact with air. This material possesses good wetting characteristics and the ability to drain excess fluid after incorporating water ions of moist air into the desiccant solution. This material is woven fiberglass cloth. The woven fibers of the cloth helps pull in desiccant fluid to adjacent dry parts with capillary action. A single long strip of a certain width is used in conjunction with two rows of spaced plastic rods to create a bank of woven fiberglass cloth strips in parallel configuration. Moist air flows through the narrow space between parallel strips and interacts with thin film of desiccant solution on both sides of strip. A very large surface area results in rapid air and desiccant interaction. Since the parallel strips are oriented vertically, increased fluid volume of the thinly coated fluid film on the fiberglass causes gravity to assist in forming droplets, rapidly being drained into the reservoir at the bottom.

Regeneration of the water diluted desiccant is accomplished by vacuum and/or heat. A regenerator using parallel woven fiberglass strips similar to dehumidifier in construction is again used for the large surface area that is wetted. The woven fiberglass strip is wider because the large amount of diluted desiccant is collected from many dehumidifiers associated with Tube-fins heat exchangers. However, the regenerator configuration can still be relatively small to fit into a small microwave oven. The regenerator (microwave transparent plastic) is placed inside a microwave oven so the right amount of controlled heat can be delivered to heat the desiccant. A vacuum is applied to lower the water evaporation temperature so only a small amount of heating is required for water molecule evaporation saving energy use. To further prevent excess use of energy, a system of solenoid and manual valves is used to prevent transport of desiccant to humidifier(s) not in operation but still delivers the pre-determined amount of desiccant to each of the operating dehumidifiers.

The narrow profile of the dehumidifier is designed to work in conjunction with a Tube-fins heat exchanger fitted inside a common wall.

### BRIEF DESCRIPTION OF THE DRAWINGS

FIG. 1 is side sectional view of a dehumidifier module showing relation of desiccant input tube carrying desiccant for wetting surface constructed of stretched woven fiberglass cloth with excess fluid draining into a reservoir to be transported for regeneration. The drawing also shows 3 rows of DC brushless muffin fans providing moist air flow to interact with wetted fiberglass cloth surface and move air through diffuser into a room.

FIG. 2 is a frontal view of dehumidifier module showing relative position of the single strip of woven fiberglass cloth being stretched by two banks of parallel plastic rods. The resulting parallel fiberglass strips provide a large surface area to interact with air on both sides of the strips. It also shows the input concentrated desiccant continuously wetting the cloth on top of the stretched strips so the solution will course down to wet the strips.

FIG. 2a is a sectional view of a heat exchanger that allows cooling of desiccant before it is processed by the dehumidifier.

FIG. 3 is a diagram showing a wall mount inline dehumidifier with a Tube-fins heat exchanger. Room air is taken into the dehumidifier by suction of the fans of heat exchanger module. Room air is dehumidified, travels through the fans, and is cooled by the Tubes-fins heat exchanger before returning to the room.

FIG. 4 is a side view of the desiccant regenerator module. This diagram shows the diluted desiccant solution applied at the top and wetting the wider fiberglass strip, and draining by gravity to the bottom reservoir to be transported for reuse.

FIG. 5 is a front view of the regenerator and shows when the vacuum being applied to decrease water evaporation temperature at the same time removing water vapor to increase regeneration rate.

FIG. 6 shows the regenerator module inside a microwave oven so temperature of the dilute desiccant can be controlled to slightly above water evaporation temperature that has been lowered by vacuum.

FIG. 7 is a system diagram of the dehumidifier and desiccant regenerator showing the provision of delivering desiccant to each dehumidifier at the same flow rate regardless of number of dehumidifiers in operation.

### REFERENCE NUMERALS IN DRAWINGS

1. Dehumidifier module
1a. Glass tube heat exchanger body
1b. Space
2. Desiccant solution input tube
2b. Silicone tube collar
2c. Input tube for desiccant
2d. Output tube for desiccant
2e. Cold secondary refrigerant fluid
2f. Processed secondary refrigerant
3. Diluted desiccant solution
4. Stretched woven fiberglass cloth strip
5. DC brushless muffin fan
6. Air diffuser
7. Air intake grill
8. Moist air in
9. Dehumidified air flow
10. Reservoir containing diluted desiccant
11. Rods to hold stretched woven fiberglass cloth strip(s)
12. Back of wall mount inline dehumidifier and Tube-fins heat exchanger guiding air flow
13. Tube-fins heat exchanger module
14. Desiccant regenerator module
14a. Dehumidified and cooled air returning to room
14b. Horizontal layer of woven fiber glass strips
15. Excess concentrated desiccant droplets entering reservoir
15a. Desiccant regenerator
16. Vacuum connector
16a. Reservoir holding concentrated desiccant for reuse
17. Microwave oven
18. Digital display for microwave oven
19. Desiccant reservoir
20. Air pressure operated diaphragm pump
21. Normally open solenoid valves
22. Normally closed solenoid valves

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

As described above, the present invention provides an apparatus and methods for dehumidification of air moisture with liquid desiccant lithium chloride or other halogens for desiccant regeneration. Woven fiberglass cloth 4 is used as a wetting and chemical interacting surface for lithium chloride and air due to its suitable physical and chemical characteristics. Essential ones are 1. Not chemically reactive with halogen, 2. Tolerates high and low temperatures, 3. Fibers are easily wetted, 4. Woven fibers assist self-wetting with capillary action, 5. Drains excess fluid easily when the cloth is oriented in vertical position.

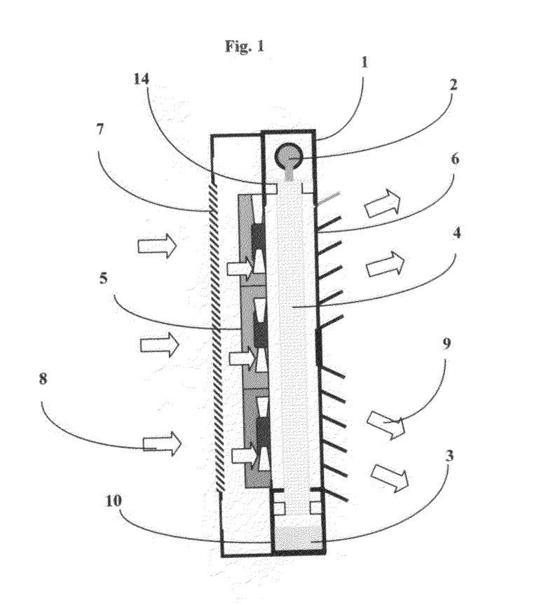

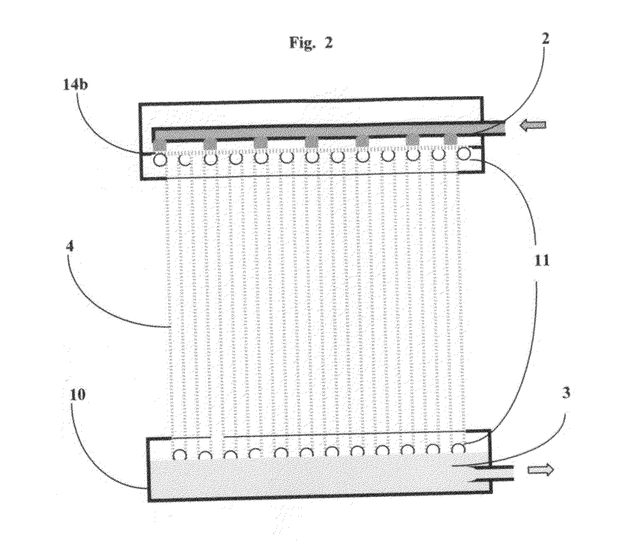

Two rows of plastic rods 11, one at top and the other at bottom FIG. 1 and FIG. 2, alternatively spaced in parallel support a single long strip of fiberglass cloth of a certain width 4 stretching alternatively up and down resulting in formation of apparent parallel closely spaced strips. This allows air to be dehumidified flowing between the formed parallel strips and interacting with a thin film of desiccant solution on both sides of the wetted fiberglass cloth strip surfaces FIGS. 2; 4. Both sides of the fiberglass cloth represent a very large surface area of the desiccant film that interacts with air.

Concentrated desiccant 2 is dispensed through a series of small holes of a plastic tube onto a multilayer of fiberglass cloth that is in contact with the fiberglass cloth strip wherever it bends around the top row of plastic rods wetting the parallel formed strips.

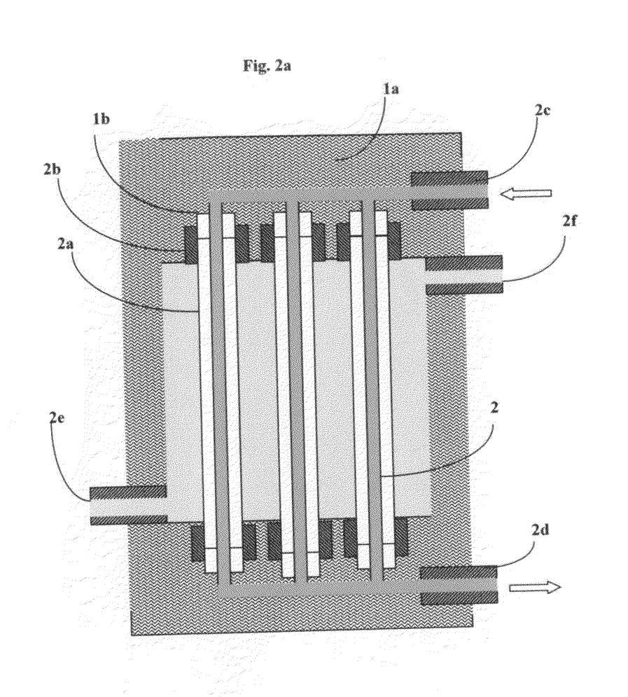

As demonstrated in FIG. 3 a dehumidifier module 1 is operating in conjunction with a Tube-fins heat exchanger module 13. Prior to the concentrated desiccant being delivered to the heat exchanger, it is cooled by a heat exchanger with Pyrex glass tubing FIG. 2a. This is a provision to lower vapor pressure of the desiccant to produce a large differential with the high vapor pressure of warm moist air. This increases the rate of incorporation of water moisture into the desiccant from air.

As air water moisture dissolves into the desiccant solution that is the thin film covering the fiberglass cloth, fluid increases volume. Since the orientation of fiberglass strips is vertical, gravity will move the hydrated fluid 3 downward forming droplets and run down the cloth into the reservoir 10 below.

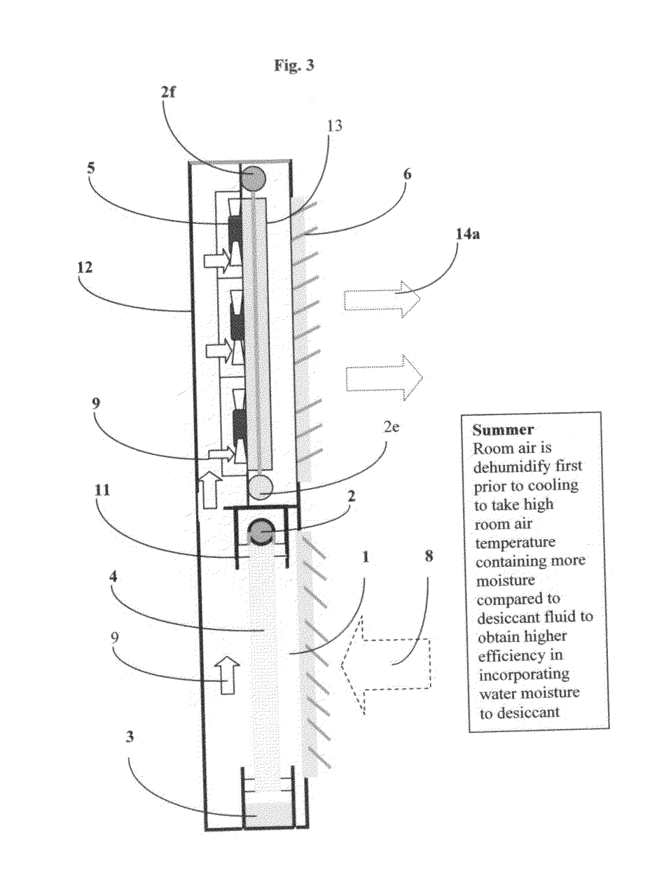

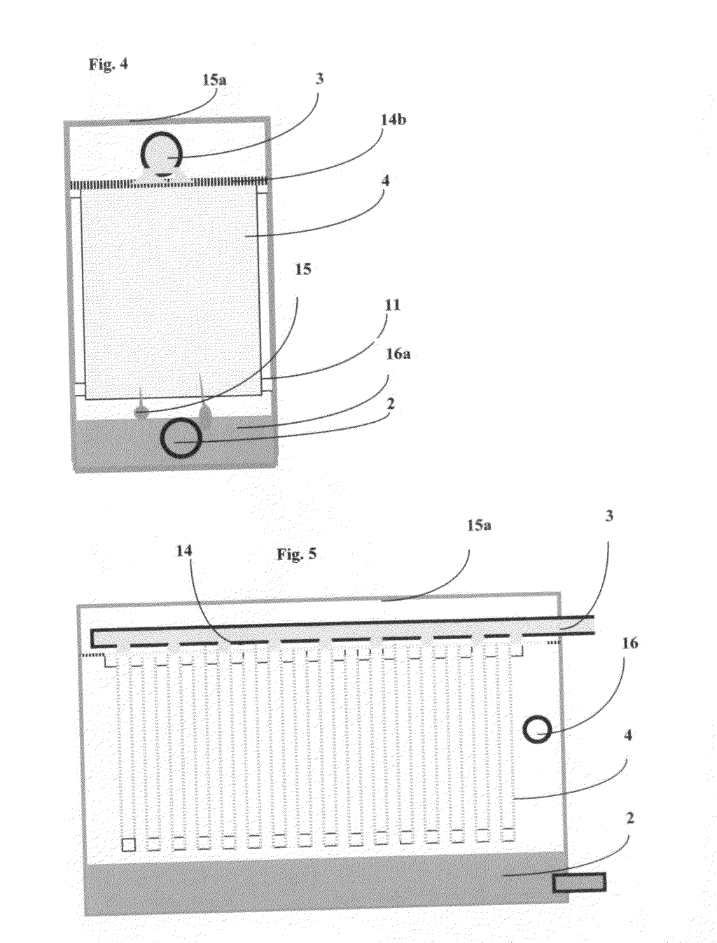

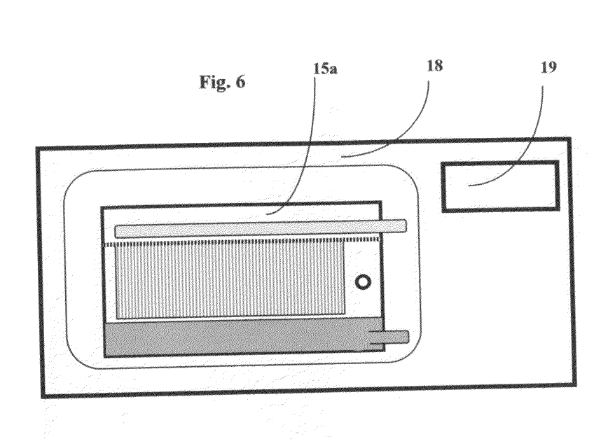

Diluted desiccant 3 is transported to a regenerator FIG. 4 and FIG. 5 constructed similarly as the dehumidifier that converts a single fiberglass strip into many formed strips by stretching between 2 rows of plastic rods. The single strip is wider because more diluted fluid is collected from multiple dehumidifiers. The regenerator is encased in an air tight enclosure 15 that is accessible to vacuum 17. Entire regenerator is placed inside a microwave oven FIGS. 6; 18. Vacuum lowers water evaporation temperature so less heat is needed (instead of boiling at 100° C.) to evaporate the water ions in the diluted desiccant. Less electricity is used for heating the diluted desiccant to the boiling point temperature in vacuum; the microwave only vibrates the desiccant solution molecules for heating and not its container and associated structure since these components are microwave transparent. Microwave oven is easily controlled with electronics to deliver heat for water evaporation. Shorter duration of heating under vacuum is electronically controlled by measurement of optical diffraction with light source and optical diffraction sensor. Water vapor from evaporation is carried away by vacuum. Water extracted is potable and can be reclaimed.

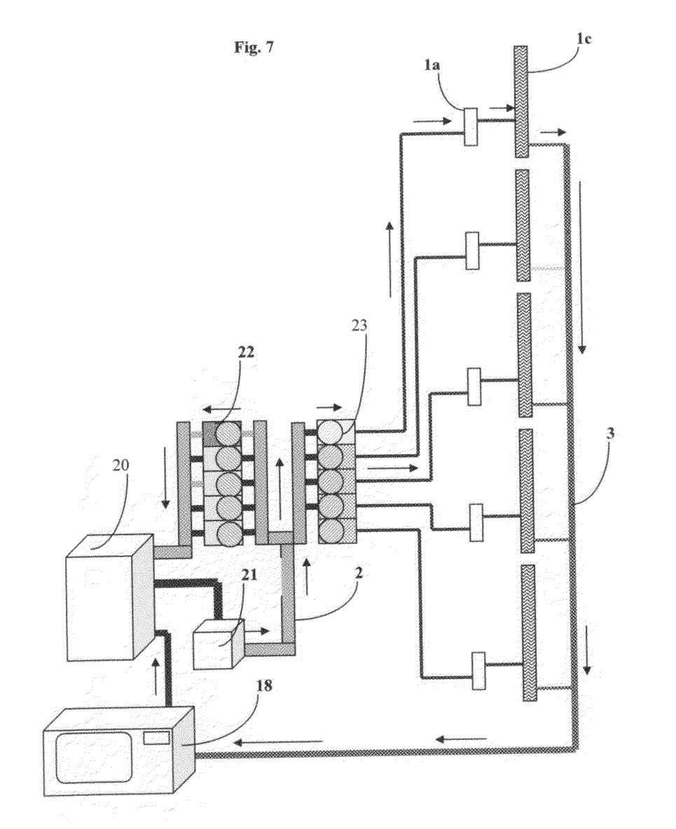

Diagram FIG. 7 shows a method that each individual dehumidifier 1c in a system can operate or not operate without affecting the amount of desiccant per unit time that is preset to be delivered to any other dehumidifier. This is done primarily with 2 groups of solenoid valves with matching flow value with one set close to the reservoir 22 that is normally open and other controlling the flow to dehumidifiers 23 that is normally closed. When a solenoid for a particular dehumidifier opens, the corresponding solenoid near the reservoir closes. Manual valves associated with each solenoid valve are not shown that preset the flow rate to each dehumidifier and return fluid to reservoir. An air pressure regulated diaphragm pump 21 is used in the system for constant delivery of desiccant flow.

What is claim is:

1. An apparatus for using a halogen such as lithium chloride solution as desiccant for dehumidification in air conditioning comprising:
means for controlling operation of a dehumidifier coupled with integrated temperature sensor and relative humidity sensor;
a perforated tube as means for delivering and spreading desiccant onto layers of woven fiberglass cloth that help drain and spread desiccant fluid onto a structure comprising air and desiccant fluid interaction surface composed of,
a single long strip of woven fiberglass cloth of certain width stretched back and forth between two rows of plastic rods alternatively placed in vertical orientation forming closely spaced slots in parallel for air to travel between the slots in the process of air dehumidification,
a dehumidifier with vertically oriented fiberglass cloth due to its non-fluid absorption characteristics allowing gravity to drain excess fluid by first forming droplets from the excess fluid desiccant volume and draining the droplets into a reservoir at the bottom of the structure to be transported to a desiccant regenerator that consists of,
an air tight regeneration module that is similar in construction to the dehumidifier with a wider long strip of woven fiberglass cloth stretched between two rows of alternatively positioned plastic rods in a vertical orientation with an addition of a tube that is connected to,
a source of vacuum that reduces the pressure in regenerator to lower water evaporating temperature of the diluted desiccant solution so this vacuum can reduce the heat required for water evaporation in concentrating desiccant for reuse that is supplied by,
a microwave oven in which the regenerator is placed that is microwave transparent if heating is needed so heating is solely directed to desiccant solution eliminating electricity consumption of heat by surrounding container.

2. The apparatus as in claim 1. wherein said fiberglass cloth is used as base for fluid to be coated due to its inherent characteristics such as non-chemical reactivity and non-absorption of fluid, for easy fluid coating and providing easy sliding surface for excess fluid to drain by gravity; all are important characteristics for coating with desiccant for moisture absorption or evaporation in regeneration.

3. The apparatus as in claims 1. and 2. also includes another unique feature; when a dehumidifier-regenerator system has multiple dehumidifiers operating in line with multiple Tube-fins heat exchangers (in separate patent application), rate of desiccant infused with each dehumidifier is preset and flow rate delivered to each dehumidifier stays the same regardless of whether one or many of the dehumidifier modules is in operation.
